(19) United States
(12) Patent Application Publication
(10) Pub. No.: US 2021/0019796 A1
(43) Pub. Date: Jan. 21, 2021

(54) PRICEBOOK TRANSACTION LOG MANAGEMENT SYSTEMS AND METHODS

(71) Applicant: ServiceTitan, Inc., Glendale, CA (US)

(72) Inventors: Andrew Litvak, Glendale, CA (US); Denis Bogdanov, Glendale, CA (US)

(73) Assignee: ServiceTitan, Inc., Glendale, CA (US)

(21) Appl. No.: 16/930,248

(22) Filed: Jul. 15, 2020

Related U.S. Application Data
(60) Provisional application No. 62/874,049, filed on Jul. 15, 2019.

(51) Int. Cl. G06Q 30/06; G06Q 20/38; G06F 16/242

(52) U.S. Cl. CPC G06Q 30/0603; G06F 16/244; G06Q 20/389

(57) ABSTRACT

The subject disclosure relates to techniques for monitoring and managing pricebooks, for example between tenants and suppliers. A process of the disclosed technology can include steps for receiving transaction event data corresponding to an interaction of one of a supplier or a tenant with one of a master pricebook or a tenant pricebook, determining at least one change between the transaction event data and a previously stored version of data associated with the one of the supplier or the tenant, and generating a set of changes based on the at least one change.

### CROSS-REFERENCE TO RELATED APPLICATION

The application claims priority to U.S. Provisional Patent Application Ser. No. 62/874,049, filed Jul. 15, 2019, the disclosure of which is incorporated by reference herein in their entirety in this disclosure.

### BACKGROUND OF THE INVENTION

### Field of the Invention

The present invention relates to monitoring and managing pricebooking software. In particular, the present invention relates to managing transaction logs for an interactive pricebooking platform.

### Description of the Related Art

As commerce grows more into electronic commerce (e-commerce), tenants (e.g. customers) and suppliers (e.g. vendors) may communicate more online. Furthermore, tenants may purchase from multiple suppliers and suppliers may sell to multiple tenants. Thus, there is a need to manage pricing between tenants and suppliers. Similarly, this problem is further compounded when some tenants receive special or tenant-specific prices from suppliers. Additionally, this problem is also compounded when tenants further have multiple accounts for different functionals departs, each of which may have special or account-specific prices.

### SUMMARY

Embodiments of the present invention generally relate to systems and methods for managing and processing pricebook transactions.

In one embodiment, a method includes receiving transaction event data corresponding to one of a supplier or a tenant interacting with one of a master pricebook or a tenant pricebook, determining a change between the transaction event data and a previously stored version of data associated with at least one of the supplier or tenant, and generating a set of changes based on the received transaction event data.

### BRIEF DESCRIPTION OF THE DRAWINGS

The description will be more fully understood with reference to the following figures, which are presented as various embodiments of the disclosure and should not be construed as a complete recitation of the scope of the disclosure, wherein:

FIG. 1 is a block diagram of an example pricebook platform and operating environment, in accordance with various embodiments of the subject technology;

FIG. 2 is a flowchart depicting an example method for updating a supplier transaction log for a pricebook platform, in accordance with various embodiments of the subject technology;

FIG. 3 is a flowchart depicting an example method for updating a tenant transaction log for a pricebook platform, in accordance with various embodiments of the subject technology; and

FIG. 4 is a flowchart depicting an example method for generating a consolidated changes report for a transaction log for a pricebook platform, in accordance with various embodiments of the subject technology; and

FIG. 5 is a diagram illustrating an example of a computing system which may be used in implementing various embodiments of the present disclosure.

### DETAILED DESCRIPTION

Aspects of the present disclosure involve systems, methods, computer program products, and the like, for managing a pricebook of supplies and service providers. The pricebook may be accessible as a master pricebook library by individual clients (e.g., tenants) who may download respectively relevant portions of the master pricebook library into a personalized tenant pricebook accessible only by the respective tenant or those authorized by the same.

In one embodiment, a method includes receiving transaction event data corresponding to one of a supplier or a tenant interacting with one of a master pricebook or a tenant pricebook, the master pricebook including a listing of offerings from the supplier and the tenant pricebook including a copy of at least a portion of information stored in the master pricebook and associated with the tenant, generating a set of changes based on the received transaction event data, the set of changes including modifications to a portion of one of the listing of offerings or the copy of at least the portion of information, aggregating the set of changes into grouped changes including net change values, and generating a report including the aggregated set of changes.

In particular, a management platform can monitor tenant downloads from the master pricebook library and provide reports of consolidated changes to tenant pricebooks based on the tenant downloads and/or tenant modifications to respective tenant pricebooks. In some examples, vendors and/or supplies may upload new products, services, and/or changes to existing offerings to the master pricebook library. Vendor and/or supplies uploads can likewise be monitored and reports of consolidated changes to offerings by vendors and/or supplies can be generated by the management platform based on the monitoring.

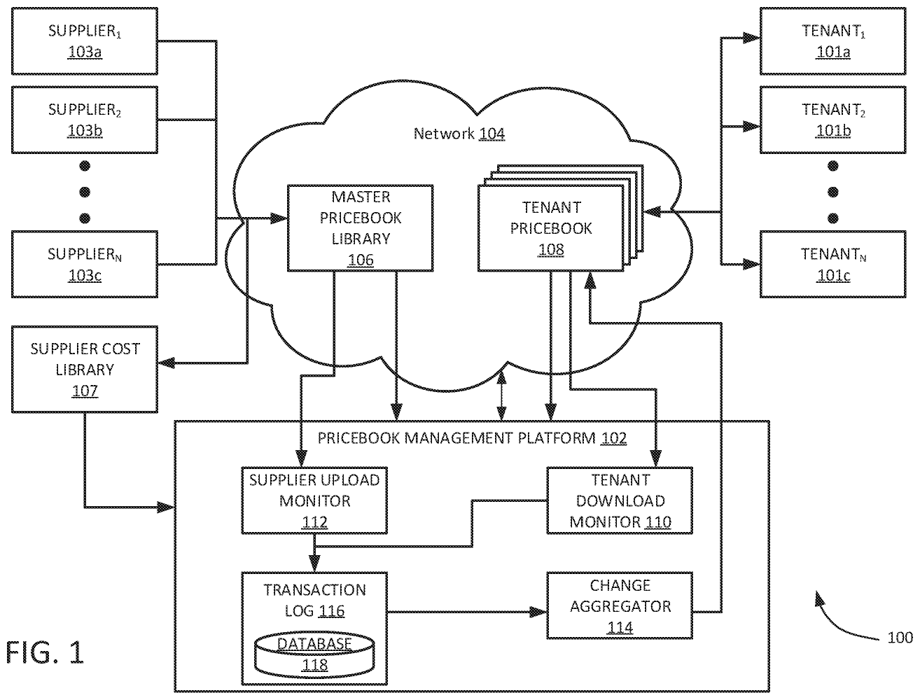

A discussion of FIGS. 1-5 follows for explanatory purposes. While various components, steps, and system architectures are provided in a particular structure and order, it is understood that they are depicted as such for explanatory purposes only. Additional components or steps may be included, or components or steps may be removed, and/or components and steps may be organized differently than depicted without departing from the spirit and scope of this disclosure.

FIG. 1 depicts an operating environment 100 in which a pricebook management platform 102 can monitor transactions by suppliers 103a-c and tenants 101a-c (e.g., clients) with various pricebooks and cost libraries. Operating environment 100 may have tenants 101a-c, pricebook management platform 102, suppliers 103a-c, and a network 104.

Network 104 may be configured to store a master pricebook library 106 and individual tenant pricebooks 108 and communicate with suppliers 103a-c, tenants 101a-c, and pricebook management platform 102. Thus, network 104 is configured to allow, provide, and/or establish remote communication and interaction among pricebook management platform 102, suppliers 103a-c, and tenants 101a-c. In some implementations where each tenant may have multiple accounts (e.g. accounts for different functional departments of a tenant), each tenant pricebook 108 may also have individual tenant account pricebooks 108. In some implementations, network 104 may be a cloud computing environment accessible through the internet. In some implementations, network 104 may also store and allow communication supplier cost library 107, suppliers 103a-c, and pricebook management platform 102.

In general, suppliers 103 a-c may provide updates to master pricebook library 106 and said updates can be logged for later review and analysis. Supplier updates can include, for example and without imputing limitation, new products or services, pricing changes, icons (e.g., for products or services), and various other information.

Furthermore, suppliers 103a-c may provide updates to supplier cost library 107. Supplier cost library can include various pricings for various products and/or services. In some implementations, supplier cost library 107 may be outside of network 104, such that suppliers 103 a-c can update pricing locally and be received into pricebook management platform 102 and/or network 104.

Likewise, a tenant 101a-c may interact with and manage a respective personalized and/or individual tenant pricebook 108 by pulling updates and/or adding selected items or services to the personalized tenant pricebook 108 from the master pricebook library 106. Further, tenant 101a-c can apply various modifications to the personalized tenant pricebook 108 such as price modifications (e.g., discounts, price increases, etc.), icons, product information, etc. In other words, tenant pricebook 108 may contain a portion of or a copy of information contained in master pricebook library 106. Additionally, in some implementations, tenants 101a-c may send requests (e.g. to pull updates and/or add/remove selected items or services to tenant pricebook 108) to pricebook management platform 102. Pricebook management platform 102 can complete the request. Additionally, pricebook management platform 102 may record the tenant transactions for later review and analysis. In some implementations, tenants 101a-c may have tenant-specific pricing from suppliers 103a-c. In these implementations, when tenants 101a-c pull updates and/or add selected items or services to their respective tenant pricebooks 108, the tenant-specific pricing will be applied to their respective tenant pricebooks 108.

Pricebook management platform 102 includes a tenant download monitor 110, a supplier upload monitor 112, a change aggregator 114, and a transaction log 116. Although shown outside of network 104, in some implementations, pricebook management platform 102 can be included in network 104. Additionally, pricebook management platform 102 may have and/or utilize one or more processors to implement tenant download monitor 110, supplier upload monitor 112, change aggregator 114, transaction log 116, and any combination thereof.

Tenant download monitor 110 interfaces with a transaction log 116, which may include a database 118 of monitored tenant and supplier transactions. Tenant download monitor 110 monitors tenant 101a-c transactions with master pricebook library 106. For example, tenant download monitor 110 can monitor and determine when tenants 101a-c add one or more items from master pricebook library 106 to their respective tenant pricebooks 108. Similarly, as another example, tenant download monitor 110 can monitor and determine when tenants 101a-c change a price in respective tenant pricebooks 108. In some implementations, tenant download monitor 110 may also monitor tenant transactions with a respective tenant pricebook 108, such as direct modifications to respective tenant pricebook 108 by the tenant (e.g., customized pricing, etc.).

A supplier upload monitor 112 monitors supplier 103a-c transactions with master pricebook library 106. Supplier upload monitor 112 interfaces with transaction log 116 for storing and retrieving monitored supplier 103a-c transactions. For example, supplier upload monitor 112 can monitor and determine when suppliers 103a-c add new products or services, change prices, etc.

Transaction log 116 is configured to interface with tenant download monitor 110, supplier upload monitor 112, and change aggregator 114. More specifically, transaction log 116 receives transactions executed by tenants 101a-c and suppliers 103a-c through tenant download monitor 110 and supplier upload monitor 112, respectively. Additionally, transaction log 116 may include a database 118 of monitored tenant and supplier transactions. Thus, transaction log 116 can store transactions executed by tenants 101a-c and suppliers 103a-c in database 118 for future analysis, review, and querying.

Change aggregator 114 communicates with transaction log 116. Change aggregator is configured to consolidate and/or aggregate changes across transaction logs (e.g., in response to a query, etc.) into grouped changes, which may be used to generate a consolidated report of total changes related to a particular pricebook, tenant, supplier, or some combination over a course of time. Thus, change aggregator 114 can aggregate transactions (e.g. a set of changes in price, available products or services, etc.) into grouped changes and identify net change values in the grouped changes. In some implementations, change aggregator 114 may also report out said reviewed changes in a consolidated fashion (e.g., generate and/or output a report to a systems administrator, development lead, etc.).

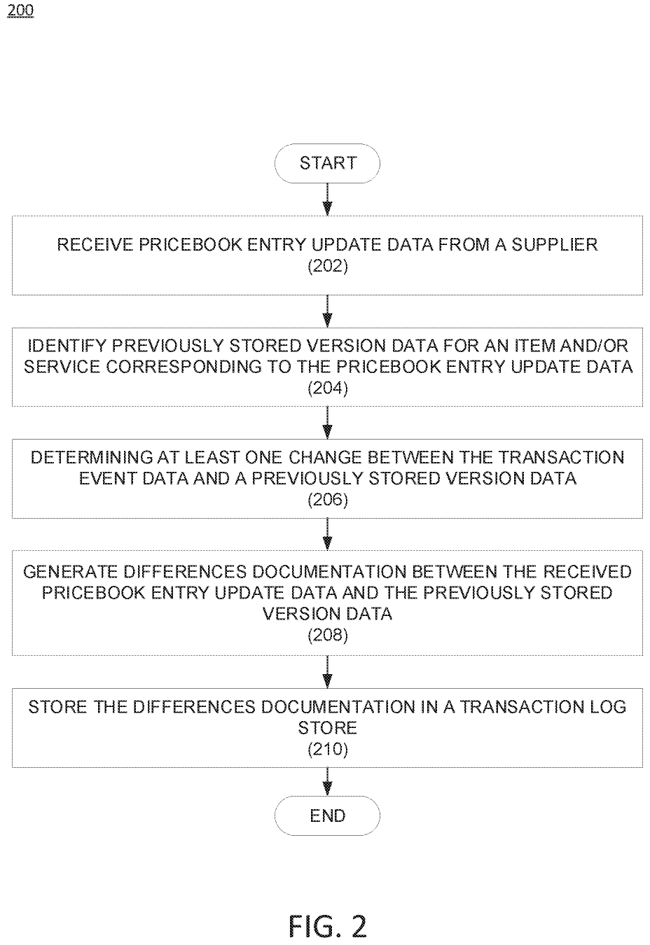

FIG. 2 depicts a method 200 for storing changes from supplier transactions in a transaction log (e.g., transaction log 116 discussed above). Although the following discussion implements method 200 from a perspective of one or more processors in network 104 and/or pricebook management platform 102, it is to be understood that any processing entity can implement method 200.

At step 202, transaction event data corresponding to an interaction between a supplier 103 and master pricebook library 106, such as a pricebook entry update, is received from the supplier. For example, supplier upload monitor 112 may observe a pricing update to items from supplier 103a in master pricebook library 106. Similarly, in some implementations, pricebook management platform 102 can associate the interaction between the supplier and an item in the master pricebook library 106.

At step 204, previously stored version data for an item and/or service corresponding to the pricebook entry update data is identified. For example, supplier upload monitor 112 may identify previous prices for the pricing update provided by supplier 103a. Thus, pricebook management platform 102 can, based on an association between the interaction between the supplier and an item in master pricebook library 106, locate and identify the previously stored version data.

At step 206, at least one change between the transaction event data and the previously stored version data is determined. For example, supplier upload monitor 112 may observe that an updated price of an item in the transaction event data is different from a previous price in the previously stored version data for the item.

At step 208, a differences documentation between the received pricebook entry update data and the identified previously stored version data is generated based on the at least one change. For example, the identified previous prices and the pricing update from supplier 103a may be compared and a differences documentation of the change in price (e.g., an increase from $1.00 a widget to $1.50 a widget) is generated.

At step 210, the differences documentation is stored in a transaction log store, such as transaction log 116 and/or database 118.

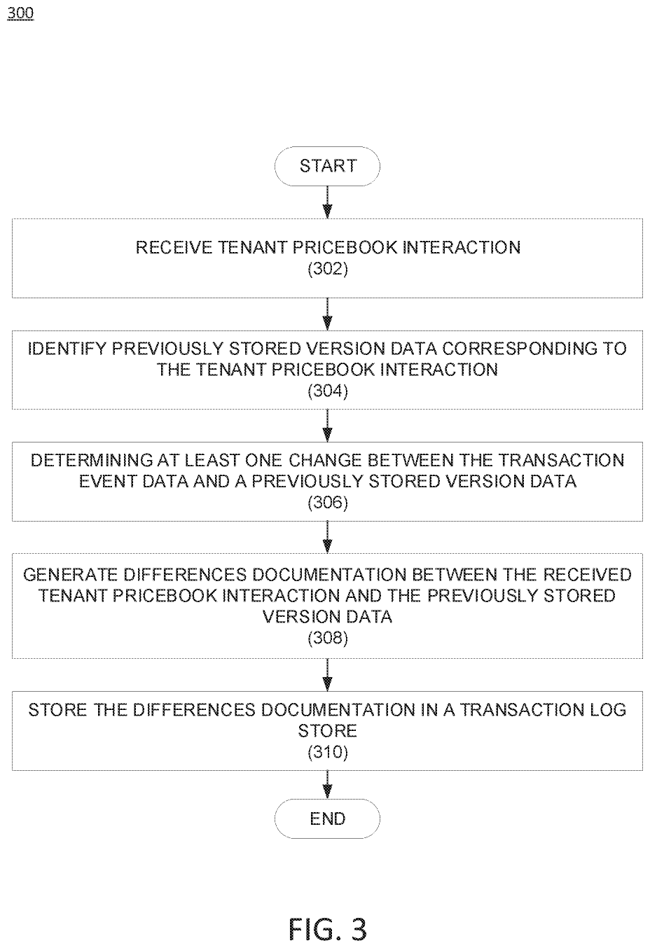

FIG. 3 depicts a method 300 for storing changes from tenant transactions in a transaction log (e.g., transaction log 116 discussed above). Although the following discussion implements method 300 from a perspective of one or more processors in the network 104 and/or pricebook management platform 102, it is to be understood that any processing entity can implement method 300.

At step 302, transaction event data corresponding to an interaction between a tenant 101 and a respective tenant pricebook 108, (e.g. a tenant initiating a master pricebook pull or tenant pricebook modification) is received. For example, tenant download monitor 110 may observe tenant 101a adding new item pricing information from master pricebook library 106 to respective tenant pricebook 108. In some implementations, the transaction event data may correspond to an interaction between a tenant account and a respective tenant account pricebook 108 Similarly, in some implementations, pricebook management platform 102 can associate the tenant pricebook interaction with an item in master pricebook library 106 and/or respective tenant pricebook 108.

At step 304, previously stored version data corresponding to the tenant pricebook interaction is identified. For example, tenant download monitor 110 may identify the specific item for which tenant 101a added new pricing information as well as the specific item's previous price. Thus, pricebook management platform 102 can, based on an association between tenant pricebook interaction and an item in master pricebook library 106 and/or respective tenant pricebook 108, locate and identify the previously stored version data.

At step 306, at least one change between the transaction event data and the previously stored version data is determined. For example, tenant download monitor 110 may determine a price difference between an item's previous price and an updated price resulting from tenant 101a adding the new pricing information.

At step 308, differences documentation between the received tenant pricebook interaction and the previously stored version data is generated based on the at least one change. For example, tenant download monitor 110 may, after determining the price difference, generate the differences documentation, which includes the price difference.

At step 310, the differences documentation is then stored in a transaction log store.

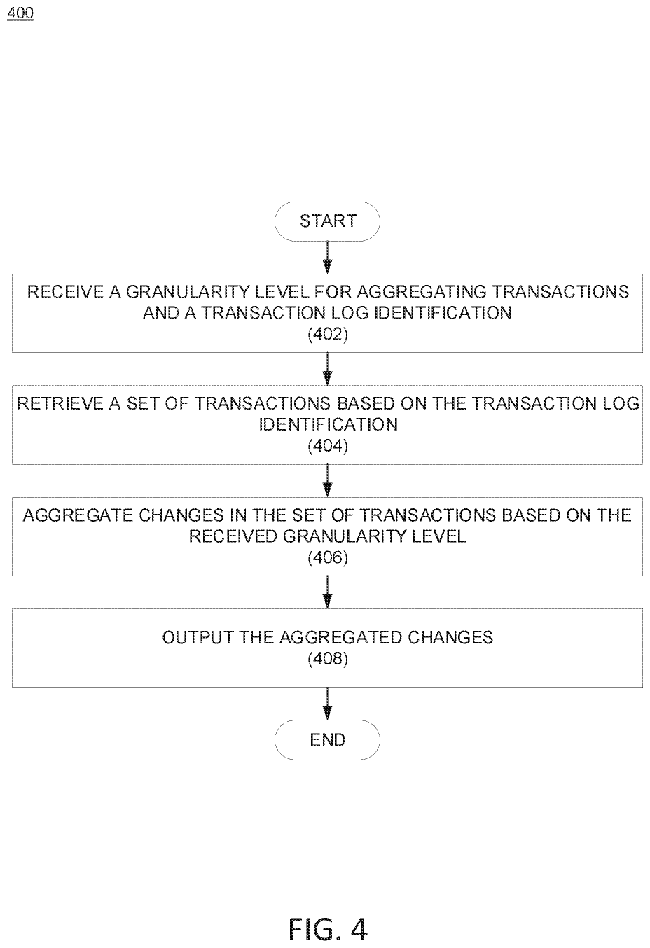

FIG. 4 depicts a method 400 for generating aggregated changes from a transaction log. For example, pricebook management platform 102 may, in response to receiving a query from an analyst, generate a report or series of reports on tenant pricing adjustments over a period of time by executing method 400.

At step 402, a granularity level for aggregating transactions and a transaction log identification is received. The granularity level may indicate a timeframe during which transactions have occurred. Similarly, the granularity level may indicate updates from specific suppliers. Additionally, the granularity level may indicate transactions or updates from specific vendors, about specific products or services, specific fields (e.g. price, available add-ons, descriptions, names), etc. For example, pricebook management platform 102 may receive a query from the analyst for aggregating transactions within the preceding month aggregated on a weekly basis for a particular tenant log.

At step 404, a set of transactions and/or changes based on the transaction log identification is retrieved. Continuing the example, the query may cause a retrieval of all transactions from the preceding month from a particular transaction log associated with the particular tenant. In other words, pricebook management platform 102 can generate a set of changes based on received transaction event data, which can be stored in database 118.

At step 406, changes in the set of transactions and/or changes are aggregated based on the received granularity level. The retrieved transaction may be aggregated into a listing of week-to-week changes spanning the preceding month. In other words, the set of changes and/or transactions can be aggregated into grouped changes for easier digestion by the analyst. Additionally, the grouped changes may identify net change values in the set of transactions and/or changes.

At step 408, the grouped changes are output. For example, the analyst can set the aggregated changes to output to a downstream process, such as a data visualization service or the like, to generate a graphical depiction of the changes. Alternatively, or at the same time, the analyst may generate a print out of the aggregated changes in a line-item format and/or the like (e.g. a report).

It is to be understood that methods 200, 300, 400 depicted in FIGS. 2-4 can be used alone or in any combination thereof.

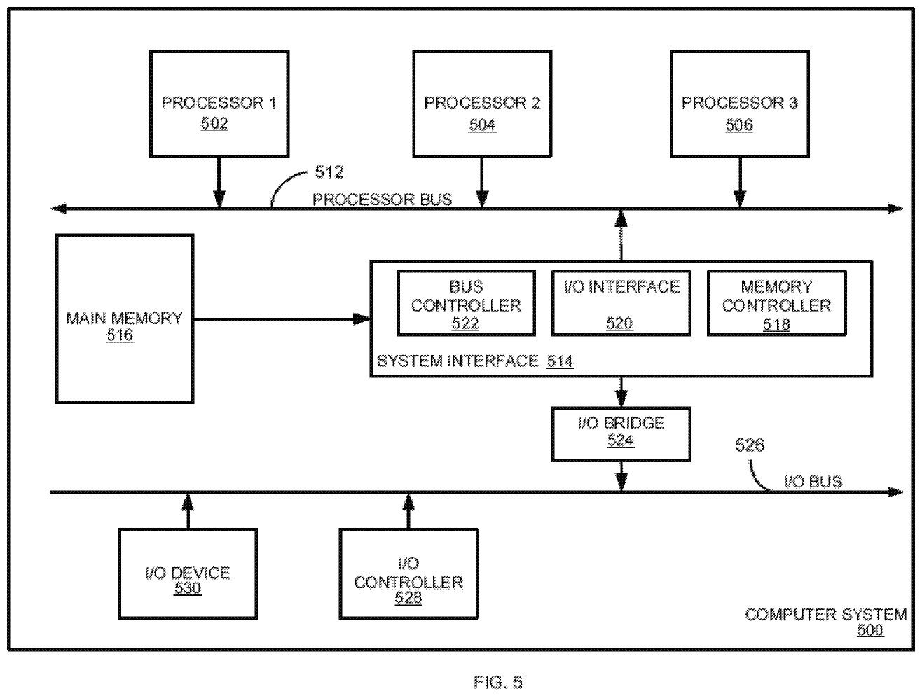

FIG. 5 is a block diagram illustrating an example of a computing device or computer system 500 which may be used in implementing the embodiments of the components of the network disclosed above. For example, the computing system 500 of FIG. 5 may be the provider edge device discussed above. The computer system (system) includes one or more processors 502-506. Processors 502-506 may include one or more internal levels of cache (not shown) and a bus controller or bus interface unit to direct interaction with the processor bus 512. Processor bus 512, also known as the host bus or the front side bus, may be used to couple the processors 502-506 with the system interface 514. System interface 514 may be connected to the processor bus 512 to interface other components of the system 500 with the processor bus 512. For example, system interface 514 may include a memory controller 514 for interfacing a main memory 516 with the processor bus 512. The main memory 516 typically includes one or more memory cards and a control circuit (not shown). System interface 514 may also include an input/output (I/O) interface 520 to interface one or more I/O bridges or I/O devices with the processor bus 512. One or more I/O controllers and/or I/O devices may be connected with the I/O bus 526, such as I/O controller 528 and I/O device 540, as illustrated.

I/O device 540 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system set forth in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-transitory media and volatile media. Non-transitory media includes optical or magnetic disks. Volatile media includes dynamic memory, such as main memory 516. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A computer-implemented method comprising:
receiving, at a pricebook management platform, transaction event data corresponding to an interaction of a supplier or a tenant with a master pricebook or a tenant pricebook;
determining at least one change between the transaction event data and a previously stored version of data associated with at least one of the supplier or the tenant; and
generating a set of changes based on the at least one change, the set of changes comprising modifications to at least a portion of a listing of offerings in the master pricebook or the tenant pricebook.

2. The computer-implemented method of claim 1, further comprising:
receiving, by the pricebook management platform, a granularity level for aggregating transactions and a transaction log identification;
retrieving the set of changes from a transaction database based on the transaction log identification;
aggregating the set of changes into grouped changes comprising net change values based on the granularity level; and
outputting the grouped changes.

3. The computer-implemented method of claim 1, wherein the transaction event data corresponds with an interaction from the tenant with the tenant pricebook, the method further comprising:
associating the transaction event data with the tenant and an offering in the listing of offerings in the tenant pricebook; and
identify the previously stored version of data based on the association between the tenant and the offering in the tenant pricebook, wherein the previously stored version of data is associated with the offering and the tenant.

4. The computer-implemented method of claim 1, wherein the tenant has a plurality of accounts and each of the plurality of accounts is associated with a respective tenant account pricebook, and wherein transaction event data corresponds with an interaction from one account of the plurality of accounts of the tenant with the respective tenant account pricebook, the method further comprising:
associating the transaction event data with the one account of the plurality of accounts of the tenant and an offering in a listing of offerings in the respective tenant account pricebook; and
identifying the previously stored version of data based on the association between the tenant account and the offering in the respective tenant account pricebook, wherein the previously stored version of data is associated with the offering and the tenant account.

5. The computer-implemented method of claim 1, wherein the transaction event data corresponds with an interaction from the supplier with the master pricebook, the method further comprising:
associating the transaction event data with the supplier and an offering in the listing of offerings in the master pricebook; and
identifying the previously stored version of data based on the association between the supplier and the offering in the master pricebook, wherein the previously stored version of data is associated with the offering and the supplier.

6. The computer-implemented method of claim 1, wherein the tenant and the supplier remotely interact with the one of the master pricebook or the tenant pricebook through a network.

7. The computer-implemented method of claim 1, further comprising:
generating differences documentation based on the set of changes; and
storing the differences documentation in a transaction log store.

8. A system comprising:
one or more processors; and
one or more memories storing computer-executable instructions, which, when executed by the one or more processors, cause the one or more processors to:
receive, at a pricebook management platform, transaction event data corresponding to an interaction of a supplier or a tenant with a master pricebook or a tenant pricebook;
determine at least one change between the transaction event data and a previously stored version of data associated with at least one of the supplier or the tenant; and
generate a set of changes based on the at least one change, the set of changes comprising modifications to at least a portion of a listing of offerings in the master pricebook or the tenant pricebook.

9. The system of claim 8, wherein the computer-executable instructions further cause the one or more processors to:
receive, by the pricebook management platform, a granularity level for aggregating transactions and a transaction log identification;
retrieve the set of changes from a transaction database based on the transaction log identification;
aggregate the set of changes into grouped changes comprising net change values based on the granularity level; and
output the grouped changes.

10. The system of claim 8, wherein the transaction event data corresponds with an interaction from the tenant with the tenant pricebook, wherein the computer-executable instructions further cause the one or more processors to:
associate the transaction event data with the tenant and an offering in the listing of offerings in the tenant pricebook; and
identify the previously stored version of data based on the association between the tenant and the offering in the tenant pricebook, wherein the previously stored version of data is associated with the offering and the tenant.

11. The system of claim 8, wherein the tenant has a plurality of accounts and each of the plurality of accounts is associated with a respective tenant account pricebook, and wherein transaction event data corresponds with an interaction from one account of the plurality of accounts of the tenant with the respective tenant account pricebook, wherein the computer-executable instructions further cause the one or more processors to:
associate the transaction event data with the one account of the plurality of accounts of the tenant and an offering in a listing of offerings in the respective tenant account pricebook; and
identify the previously stored version of data based on the association between the tenant account and the offering in the respective tenant account pricebook, wherein the previously stored version of data is associated with the offering and the tenant account.

12. The system of claim 8, wherein the transaction event data corresponds with an interaction from the supplier with the master pricebook, wherein the computer-executable instructions further cause the one or more processors to:
associate the transaction event data with the supplier and an offering in the listing of offerings in the master pricebook; and
identify the previously stored version of data based on the association between the supplier and the offering in the master pricebook, wherein the previously stored version of data is associated with the offering and the supplier.

13. The system of claim 8, further comprising a communication service configured to establish communications among the one or more processors, the tenant, and the supplier for the tenant and the supplier to remotely interact with the one of the master pricebook or the tenant pricebook.

14. The system of claim 8, wherein the computer-executable instructions further cause the one or more processors to:
generate differences documentation based on the set of changes; and
store the differences documentation in a transaction log store.

15. A non-transitory computer-readable medium comprising computer-executable instructions, which, when executed by one or more processors, cause the one or more processors to:
receive transaction event data corresponding to an interaction of a supplier or a tenant with a master pricebook or a tenant pricebook;
determine at least one change between the transaction event data and a previously stored version of data associated with at least one of the supplier or the tenant; and
generate a set of changes based on the at least one change, the set of changes comprising modifications to at least a portion of a listing of offerings in the master pricebook or the tenant pricebook.

16. The non-transitory computer-readable medium of claim 15, wherein the computer-executable instructions further cause the one or more processors to:
receive, by the pricebook management platform, a granularity level for aggregating transactions and a transaction log identification;
retrieve the set of changes from a transaction database based on the transaction log identification;
aggregate the set of changes into grouped changes comprising net change values based on the granularity level; and
output the grouped changes.

17. The non-transitory computer-readable medium of claim 15, wherein the transaction event data corresponds with an interaction from the tenant with the tenant pricebook, and wherein the computer-executable instructions further cause the one or more processors to:
associate the transaction event data with the tenant and an offering in the listing of offerings in the tenant pricebook; and
identify the previously stored version of data based on the association between the tenant and the offering in the tenant pricebook, wherein the previously stored version of data is associated with the offering and the tenant.

18. The non-transitory computer-readable medium of claim 15, wherein the tenant has a plurality of accounts and each of the plurality of accounts is associated with a respective tenant account pricebook, and wherein transaction event data corresponds with an interaction from one account of the plurality of accounts of the tenant with the respective tenant account pricebook, wherein the computer-executable instructions further cause the one or more processors to:
associate the transaction event data with the one account of the plurality of accounts of the tenant and an offering in a listing of offerings in the respective tenant account pricebook; and
identify the previously stored version of data based on the association between the tenant account and the offering in the respective tenant account pricebook, wherein the previously stored version of data is associated with the offering and the tenant account.

19. The non-transitory computer-readable medium of claim 15, wherein the transaction event data corresponds with an interaction from the supplier with the master pricebook, wherein the computer-executable instructions further cause the one or more processors to:
associate the transaction event data with the supplier and an offering in the listing of offerings in the master pricebook; and
identify the previously stored version of data based on the association between the supplier and the offering in the master pricebook, wherein the previously stored version of data is associated with the offering and the supplier.

20. The non-transitory computer-readable medium of claim 15, further comprising a communication service configured to establish communications among the one or more processors, the tenant, and the supplier for the tenant and the supplier to remotely interact with the one of the master pricebook or the tenant pricebook.
